(19) United States
(12) Patent Application Publication
(10) Pub. No.: US 2019/0217223 A1
(43) Pub. Date: Jul. 18, 2019

(54) PARRWASH

(71) Applicant: Donald B. Parr, Pulaski, TN (US)

(72) Inventor: Donald B. Parr, Pulaski, TN (US)

(21) Appl. No.: 15/870,964

(22) Filed: Jan. 14, 2018

(51) Int. Cl. B01D 21/00; C02F 1/00

(52) U.S. Cl. CPC B01D 21/0012; C02F 2103/44; B01D 21/0042; C02F 1/001

(57) ABSTRACT

The present disclosure provides a movable device and system for the application of pressurized fluid, collection of that fluid, and cleaning and recycling of that fluid for subsequent use. An application of the current device is in the washing of items, for example, automobiles.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

All patents and publications described or discussed herein are hereby incorporated by reference in their entirety.

### BACKGROUND

### Technical Field

The present disclosure relates to a washing system. More particularly, the present disclosure relates to a moveable automobile washing system that can recycle and cleanse the water used during the washing process for subsequent use by the washing system.

Generally, the automobile washing systems, sometimes called carwashes or carwash stations, are known in the art. Most of these systems are commercial-based carwashes in which vehicles move through an automated machine. Alternately, the commercial carwashes includes individual bays for manual washing. Some of these stations or bays have some type of water reclamation system. However, this reclamation typically involves components permanent built into the location of the car washing station.

Additionally, portable spray washers, spray foamers, and the like are known in the art. These devices typically will attach to a water supply system and provide high pressured fluid, such as water, for some desired process. These devices can introduce chemicals into the spray or water discharged.

Some of the prior art attempts in this area include the following U.S. Pat. Nos. 4,315,270; 4,309,788; 4,383,935; 5,897,297; 5,996,907; 6,571,805; 7,344,640; 7,959,091; and 8,556,192.

Problems associated with these prior devices include a lack of portability or a lack of recycling in the systems. Generally, the portable devices lack any ability to recycle the fluid to which they are using. Most of the portable devices simply attach to a fluid line, or have tanks with fluid in them and simply produce that fluid out of hose or nozzle for the desired process, such as cleaning an object. Alternately, the prior items that have a recycling component or a cleaning component are restricted to a particular location. This is due to the fact that the cleaning or recycling portion is permanently imbedded at the location of the cleaning. For example, the automated carwashes or carwash bays that have recycling or cleaning capabilities have those abilities fixed typically underground at the location of the facility.

What is needed then is an efficient, effective, and mobile device used to clean objects, such as automobiles, and possessing the capability to recycle the fluid used during cleaning. Preferably the recycling of the fluid includes a cleansing or cleaning of the fluid within the needed device. This device is lacking in the art.

### BRIEF SUMMARY

The present disclosure provides a device and system for the application of pressurized fluid, collection of that fluid, and cleansing and recycling of that fluid for subsequent use. An application of the current device is in the washing of items, for example, automobiles.

In an embodiment, the system includes a frame that supports and houses the various components. A vacuum is operatively attached to an intake conduit. The intake conduit, from a force from the vacuum, draws the fluid into a vacuum tank wherein the fluid settles and can be discharged from the tank. Preferably this discharge of the fluid is inputted into a first cleaning tank that is designed to separate impurities such as oils and separate solids from the fluid. The fluid then can be transferred to a second liquid holding compartment where a lamella-style incline plate clarifier is used to further separate the impurities from the fluid.

In this second liquid holding compartment, a coagulant can be introduced to further solidify floating and/or dissolved particles with in the fluid to have those particles drop to the bottom of the second liquid holding compartment. There the particles can be gathered and discharged by a discharge pump out of the system. The fluid can then be transferred to a third liquid holding compartment where it can be further processed. In this third liquid holding compartment, a defoamer can be introduced as well as any needed aeration or other components to properly process the fluid. Additionally, if there has been some fluid lose in the process, it can be added in this third liquid holding compartment. An exit from the third liquid holding compartment is operatively attached to a pressure pump and discharged conduit wherein the processed fluid can then be reused for its intended purpose.

It is, therefore, a general object of the current disclosure to provide a movable or portable washing system that reclaims fluid for use in the washing process. The present invention may be movable or portable by being free/not attached from/to the support surface of the present invention.

Another object of this present invention is to provide a moveable washing system that reclaims and processes fluid used during the washing process for subsequent use by the same device.

Another object of the present invention is the reclamation of fluid used in a washing process that allows, meets or exceeds pretreatment regulations for automobile wash discharging from the fluids reclaimed during the automobile washing process.

Another object of the present invention is to provide a system for the reclamation of water during a washing process that reduces the overall cost of the water used in the process.

Numerous other objects, features and advantages of the present invention will be readily apparent to those skilled in the art upon a reading of the following description when taken in conjunction with the accompanying drawings.

### BRIEF DESCRIPTION OF THE DRAWINGS

FIG. 1 is a schematic drawing of a system made in accordance with the current disclosure.

FIG. 2 is an image of a system made in accordance with the current disclosure.

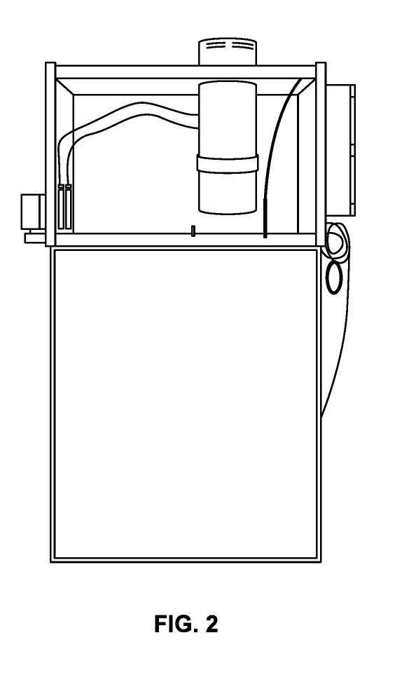

### DETAILED DESCRIPTION

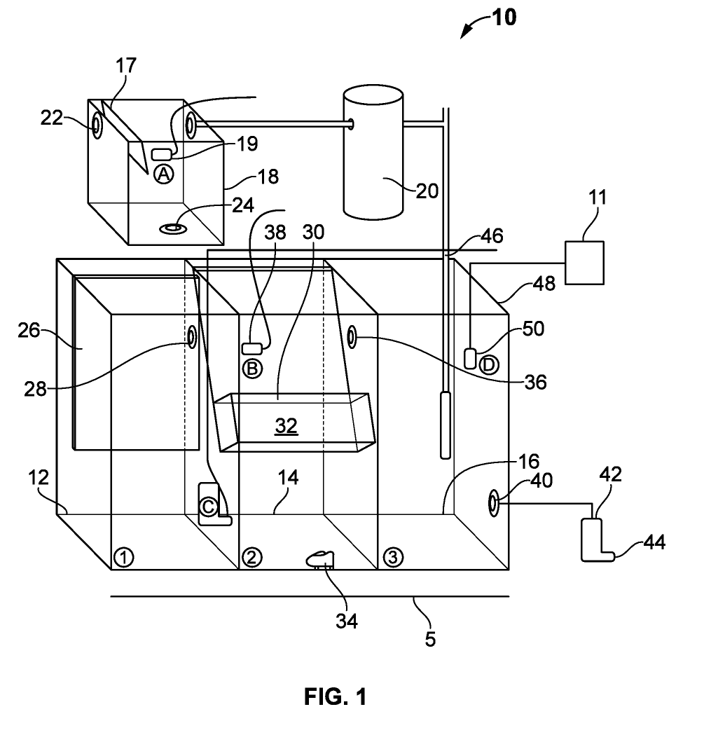

Referring now generally to FIGS. 1 and, one embodiment of the present disclosure provides a system 10 for the reclamation of wastewater during a washing process. The system 10 may be movably connected to the support surface 5 which may be a concrete floor. The system 10 includes first, second, and third liquid holding compartments/containers 12, 14, and 16 respectively, which can also be described as holding tanks or processing tanks. These liquid holding compartments 12, 14, and 16 are fluidly connected to each other.

The first liquid holding compartment 12 is connected to a vacuum tank 18 which is operatively attached to a vacuum 20 and an intake conduit 22. The intake conduit 22 absorbs the fluid which may be contaminated from a force imparted by the vacuum 20 through the vacuum tank 18. Intake conduit 22 can be those items known in the industry to intake fluid, such as a hose with a proper nozzle or receptacle at the end. Alternately, the intake conduit 22 may be a collection tank used to collect the fluid used in the washing process.

The fluid can be moved through the intake conduit 22 and into the vacuum tank 18 by a vacuum 20. Within the vacuum tank 18, there can be a vacuum tank baffling/panel 17 used to direct the fluid into a desired location within the vacuum tank 18. This facilitates the fluid to remain in the vacuum tank 18 and not transferred to the vacuum 20. Additionally, a sensor 19 can be positioned within the vacuum tank 18. This vacuum tank sensor 19 can be a safety sensor used to control the vacuum 20 when the fluid level within the vacuum tank 18 gets to an undesirable level. This vacuum fluid sensor 19 can also indirectly control the opening 24 in the vacuum tank 18 that communicates with the first liquid holding compartment 12. The opening 24 can have a valve or other fluid control to regulate the flow of fluid from the vacuum tank 18 to the first liquid holding compartment 12. The filter or a valve can be controllable by the logic controller 11 of the system 10. The fluid can flow from the vacuum tank 18 through the opening 24 into the first liquid holding compartment 12.

The fluid enters the first liquid holding compartment 12 through an opening in the top of the first liquid holding compartment 12 and proceeds to a first side of the baffle/panel 26. Particles in the fluid can settle to the bottom of the first liquid holding compartment 12. Oil, since it is lighter than water, the fluid typically used in washing items, will maintain its position on top of the water. Further, since the baffle 26 preferably extends the full width of the first liquid holding compartment 12, the oil will remain on the first side of the baffle. As the water flows down and around the baffle, the oil does not flow with it. On the second side of the baffle 26 is a first transfer channel 28, or first opening, between the first tank 12 and the second 14.

This first transfer channel 28 can include a filter or valve as desired. This facilitates movement of the liquid from the first holding tank 12 to the second holding tank 14. Additionally, a discharge pump (not shown) can be operatively connected to the bottom area of the second holding tank 14. This discharge pump can remove sludge and solidified impurities from the second holding tank 14. In practice, a grate or filter-type device can be spaced from the bottom of the second holding tank 14. This can allow the impurities to fall to the bottom to a removable location for their removal through the discharge pump.

As the liquid transfers to the second holding tank 14, a lamella-style incline plate clarifier 30 is positioned which may extend the width of the second holding tank 14. A lamella clarifier or inclined plate settler (IPS) is a type of settler designed to remove particulates from liquids.

They are often employed in primary water treatment in place of conventional settling tanks. They are used in industrial water treatment. Unlike conventional clarifiers, they use a series of inclined plates. These inclined plates provide a large effective settling area for a small footprint. The inlet stream is stilled upon entry into the clarifier. Solid particles begin to settle on the plates and begin to accumulate in collection hoppers at the bottom of the clarifier unit. The sludge is drawn off at the bottom of the hoppers and the clarified liquid exits the unit at the top over a weir

The liquid within the second holding tank 14 will enter the second holding tank 14 on the backside of the clarifier 30 and travel down the second holding tank 14 behind the clarifier 30. The clarifier 30 extends the full width, and/or depth, of the second holding tank 14. There is a filtering area 32 of the clarifier 30 through which the fluid travels as it moves from the backside of the clarifier 30 through to the front side of the clarifier 30. This filtering area further helps cleanse and filters the liquid. A coagulator that causes coagulation (clumping or solidifying). is formed in the holding tank 14 to solidify particles floating within the liquid. These particles will then drop to the bottom of the second holding tank 14 and can be removed by the discharge pump 34.

The liquid, once it passes through the filtering area 32, can pass through an opening 36 between the second holding tank 14 and the third holding tank 16. This opening 36 can include an additional screen, filter, or valve as desired. A sensor 38 can be positioned in the second holding tank 14 (for example on the wall of the tank 14) to monitor the level of liquid within the second holding tank 14. If this level gets too high, the sensor 38 can initiate through the logic controller 11, the discharge pump 34 to remove fluid from the second holding tank 14.

The liquid, as it passes through opening 36, enters the third holding tank 16. The third holding tank 16 can include an opening 40 connected to a high pressure pump 42 that is connected to a discharge conduit 44 and/or a hose or nozzle. The high pressure pump 42 through the discharge conduit 44 can send the fluid to its use and operation as desired by an operator of the system 10, for example, washing items such as automobiles. Within the third holding tank 16, there can be a fluid applicator 46, such as an aerator 46, that add fluid, such as a liquid or gas, including oxygen, to the liquid in the third holding tank 16. Alternately, this fluid applicator can add other liquids or gases as desired.

Additionally, the third holding tank 16 can include another chemical applicator 48 in which additional products can be added to the liquid contained therein. The chemical applicator 48, can, for example, add a defoamer to the fluid to remove foam that has been introduced into the fluid.

Further, a sensor 50 can be included in the third holding tank 16 to connect to the logic controller 11. This sensor 50 can regulate the amount of liquid within the third holding tank 16 by reading the level of the liquid in that third holding tank 16. When the liquid gets to a predetermined level, the sensor 50 can activate the high pressure pump 48 to discharge the fluid. This sensor 50 can be a float valve, or a high water level sensor 50, or other sensors known in the art. Additionally, through the fluid applicator 46, additional fluid can be added to the third holding tank 16 as desired. This can be beneficial for example if there needs to be “make-up water” to properly supply the system 10 for the cleaning as desired. For example, additional fresh make-up water can be added to third holding tank 16 to supply the high pressure pump 42 and discharge conduit 44 with a proper amount of water to wash items as intended by the system 10.

In operation, the system 10 can be filled to a desired capacity with fresh liquid, such as water. Each tank can have applied to it fresh water to fill them up to a desired starting or operating level. Once the high pressure pump 42 is turned on, water will flow through the discharge conduit 44 to clean items as desired by a user of the system 10. An intake conduit 22 can be proximate the item being washed by the system 10. The intake conduit 22 can use a force from the vacuum 20 to vacuum up the water into the vacuum tank 18.

During the operation, the water can hit the vacuum tank baffle 17 and drop into the vacuum tank 18. The opening 24 can be regulated such that the sensor 50 or the vacuum fluid sensor 19 can regulate when the opening 24 opens to allow fluid to pass to the first holding tank 12. These switches are connected to a logic control 11, which can be described as a programmable logical control which can generally control the operation of the system 10. The opening 24 can be a check valve that can close on a high vacuum pressure and open on a low vacuum pressure while in the vacuum fluid sensor 19 can be a float switch or other type sensor used to monitor the water level in the vacuum tank 18.

Once the liquid is in the first holding tank 12, it takes the path as previously described moving in front of the baffle 26 with the water flowing under and around to the opening 28 between the first holding tank 12 and second holding tank 14. Again, solids can fall to the bottom of the first holding tank 12 and be picked up by a discharge pump 27. As the level of fluid increases in the first holding tank 12 as received from the vacuum tank 18, the water level rises to a point where it enters that opening 28 and flows into the second holding tank 14.

In the second holding tank 14, the liquid flows, as previously described, behind the clarifier 30 and through the filtering area 32 up to the opening 36. The discharge pump 34 can remove particles that fall to the bottom of the second holding tank 14 as induced by the introduction of a coagulant into the second holding tank 14. As the fluid rises, it passes through opening 36 and into the third holding tank 16. In the third holding tank 16, make-up water and gases, such as air, can be added through the fluid applicator 46, which can include a liquid conduit and a gas conduit, or aerator. This make-up water and oxygen can be added into the fluid while in the third holding tank 16. The sensor 50 can regulate when the high pressure pump 42 is activated such that the water can continue through the discharge conduit 44 and continue the cleaning process that the user of the system 10 desires. Additionally, in the third holding tank 16 a chemical applicator 48 can apply a defoamer or other chemicals as desired to the fluid. The applicator 46 can include a valve 47 to regulate the flow of liquid and gas into the third holding tank 16. This valve 47 can again be controlled by the logic controller 11.

In a preferred embodiment, the system 10 can contain 360 gallons of liquid, such as water, and can be described as a self-contained wash water recovery system. The system has a modular wash treatment capability that can meet or exceed pretreatment regulations for automobile washing and water discharge. The device can be moved and relocated.

The system 10 can include first, second, and third holding tanks 12, 14, and 16 that can each hold 120 gallons of fluid. The system 10 has a control panel, such as the logic controller 11 that can be a Micrologix 820 PLC that can be modified and programmed and preset as desired by the user for efficient operation. The system can be set up for remote control operation of the system 10, such as Wi-Fi or internet connectivity.

The system 10 can include a square steel tubing exoskeleton frame with high density polyethylene walls and internal dividers between the holding tanks 12, 14 and 16. The system 10 is capable of a totally closed loop operation with a reclamation of approximately 100% of the water used during the washing process. This can be accomplished by gravity separation of oils and settable solids from the water used to clean. A second aspect of the system 10 includes a coagulation mixed into the water to further remove particles from the water. These particles have settled to the bottom and removed, such as pumped into a sanitary sewer system. The resulting clean water then overflows into the third holding tank 16 which can have a reservoir for the water used in the cleaning process.

The system 10 can use its high pressure pump 42 to replace a traditional pressure washer and alleviates bacteria and other items within the water by oxygenation, coagulation, and removal of sludge and sediment.

The system 10 can be programmable to use a preferred, or desired, amount of reclaimed water for return to the cleaning operation. There is a control knob which allows a percentage of the water to be reclaimed and adjusted based upon the amount of contaminants washed off the automobiles.

1) A moveable washing system for reclaiming and processing fluid, comprising:
a first holding compartment for holding the fluid;
a second holding compartment in fluid in fluid communication with the first holding compartment;
a third holding compartment in fluid communication with the second holding compartment;
a support surface to support the movable washings system; and wherein the movable washing system is movable across the support surface.

2) A moveable washing system for reclaiming and processing fluid as in claim 1, wherein the movable washing system includes an inlet conduit to receive the fluid.

3) A moveable washing system for reclaiming and processing fluid as in claim 2, wherein the movable washing system includes a vacuum tank connected to the inlet conduit.

4) A moveable washing system for reclaiming and processing fluid as in claim 2, wherein the vacuum tank is connected to a vacuum device to generate a vacuum.

5) A moveable washing system for reclaiming and processing fluid as in claim 1, wherein the first holding compartment includes a tank baffling device to baffle the input fluid.

6) A moveable washing system for reclaiming and processing fluid as in claim 3, wherein the vacuum tank includes a sensor to control the fluid level within the vacuum tank.

7) A moveable washing system for reclaiming and processing fluid as in claim 1, wherein the first holding compartment is connected to the second holding compartment by a first transfer channel.

8) A moveable washing system for reclaiming and processing fluid as in claim 7, wherein the first transfer channel includes a filter to filter the fluid flowing between the first holding compartment and the second holding compartment.

9) A moveable washing system for reclaiming and processing fluid as in claim 1, wherein the second holding compartment includes the discharge pump to remove unwanted material from the second holding compartment.

10) A moveable washing system for reclaiming and processing fluid as in claim 1, wherein the second holding compartment includes a clarifier.

11) A moveable washing system for reclaiming and processing fluid as in claim 10, wherein the clarifier includes a plurality of inclined plates.

12) A moveable washing system for reclaiming and processing fluid as in claim 1, wherein the third holding compartment includes a high pressure pump to discharge the cleaning fluid.
